(19) United States
(12) Patent Application Publication
(10) Pub. No.: US 2007/0078981 A1
(43) Pub. Date: Apr. 5, 2007

(54) Wireless data transfer method and circuit

(76) Inventors: William P. Alberth JR., Prairie Grove, IL (US); Daniel J. Declerck, Lake Barrington, IL (US); Ilya Gindentuller, San Diego, CA (US)

Correspondence Address: MOTOROLA INC, 600 NORTH US HIGHWAY 45, ROOM AS437, LIBERTYVILLE, IL, 60048-5343, US

(21) Appl. No.: 11/241,719

(22) Filed: Sep. 30, 2005

(51) Int. Cl. G06F 15/173

(52) U.S. Cl. 709/225

(57) ABSTRACT

Disclosed herein are a method and a circuit for indicating data transfer rate in a data transfer transaction in place of indicating the wireless link quality. At another time, the mobile communication device may indicate a quality of a wireless link 202. Upon initiation of the wireless transfer of data 204, the method includes determining the transfer data rate throughput value 210 and annunciating the transfer data rate throughput value 212. The data will be transferred in some data transfer units (for example, bits, bytes or packets) and therefore the data transfer rate in the data transfer units is annunciated to the user in place of indicating the wireless link quality.

### FIELD OF THE INVENTION

The present invention relates to wireless data transfer, and more particularly a method and circuit for determining a data throughput value and annunciating the throughput value.

### BACKGROUND OF THE INVENTION

Mobile communication devices transfer data signals wirelessly, to and from other wireless communication capable devices, such as remote radio towers or base transceiver stations. The data transferred oftentimes is voice data, facilitating telephone calls between users. However, other types of data may be transferred as well. For example, software and content can be transferred wirelessly from a provider to a mobile communication device such as a cellular telephone. Additionally, many cellular devices are equipped with, for example, Internet access. These communications can take place in a more structured environment involving a network infrastructure including prepositioned base transceiver stations, or can involve more impromptu Ad hoc type networks. Furthermore, these communications can involve a variety of different types of technologies and protocols. As the number and types of data services increase, and become more deeply entrenched in our daily lives, there are increasingly more opportunities to use a mobile communication device to receive and transmit data in addition to voice data.

Mobile communication devices such as cellular telephones have traditionally included a signal strength icon on their display devices. The icon can change, adding or eliminating bars, according to the signal strength, in substantially real time. Voice communications generally do not require relatively high rates of data. Furthermore, voice data is heavily protected, therefore, generally a user will not notice missing bits. Accordingly, providing to the user information such as wireless link quality, which informs a user that a minimally sufficient connection, which is strong enough to establish and maintain a call is sufficient for the transfer of voice data.

The advantage of higher data rates become more pronounced for applications other than real time voice communications, where a relatively low finite amount of information is sufficient to recreate the audio signal, and the rate at which the data associated with the audio signal is continuously being produced during the conversation is relatively low. Alternatively, a data download can differ for example in that the download often involves a finite amount of preexisting data, which is known in advance. Any change in the transfer data rate throughput generally directly affects the download time. Consequently, increases in signal strength even relatively small ones, and correspondingly noise margin, enables higher data throughput, which allows predetermined finite amounts of data to be communicated more quickly. Still further, even relatively small changes in noise margin can meaningfully affect data throughput. As a result, the ability to monitor changes in signal strength information may be insufficient to inform the user that the mobile communication device is operating at full or close to full capacity when receiving data other than voice data.

As with voice data reception quality, position and orientation of the mobile communication device may change the transfer data rate throughput. In particular however, for data transfers even for small distances, changes in position and orientation can affect throughput rates. As with any type of radio signal receiving device, for example, a television having reception equipment such as rabbit ears antennae, physically moving and/or reorienting a mobile communication device can change the data transfer throughput rate. More immediately knowing the change in value of the data transfer throughput rate while a data transfer transaction is taking place could help a user to maximize the throughput according to the position and orientation of the mobile communication device. Because small changes in signal strength can materially affect data throughput, which may not be measurably distinct using standard annunciated signal strength information, the use of an alternative status indicator may be beneficial. Consequently, an indication, which more directly informs the user of data throughput, during data transfers, would be beneficial.

### BRIEF DESCRIPTION OF THE DRAWINGS

FIG. 1 shows an embodiment of a mobile communication device, some of its components, a remote radio communication apparatus and most particularly, display elements including first a wireless link quality indicator and then the transfer data rate throughput indicator in place of the wireless link quality indicator;

FIG. 2 is a flow chart of an embodiment of the method described herein for initiating the transfer data rate throughput value and annunciating the rate in place of the wireless link quality indicator;

FIG. 3 is a flow chart of an embodiment of the method including indicating the signal strength value for a plurality of networks; and

FIG. 4 is a flow chart of an embodiment of the method for indicating the transfer data rate throughput value for at least a second system while there is a first data transfer transaction occurring.

### DETAILED DESCRIPTION OF THE INVENTION

Disclosed herein are a method and a circuit for indicating data transfer rate in a data transfer transaction in place of indicating the wireless link quality. At another time, the mobile communication device may indicate a quality of a wireless link. However upon initiation of the wireless transfer of data, the method includes determining the transfer data rate throughput value and annunciating the transfer data rate throughput value. The data will be transferred in some data transfer units (for example, bits, bytes or packets) and therefore the data transfer rate in the data transfer units is provided to the user on the display device of the mobile communication device in place of indicating the wireless link quality. Additionally, where the mobile communication device to receive a plurality of data transfers simultaneously, a plurality of data transfer rates of the plurality of data transfer transactions are indicated in place of indicating a wireless link quality.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

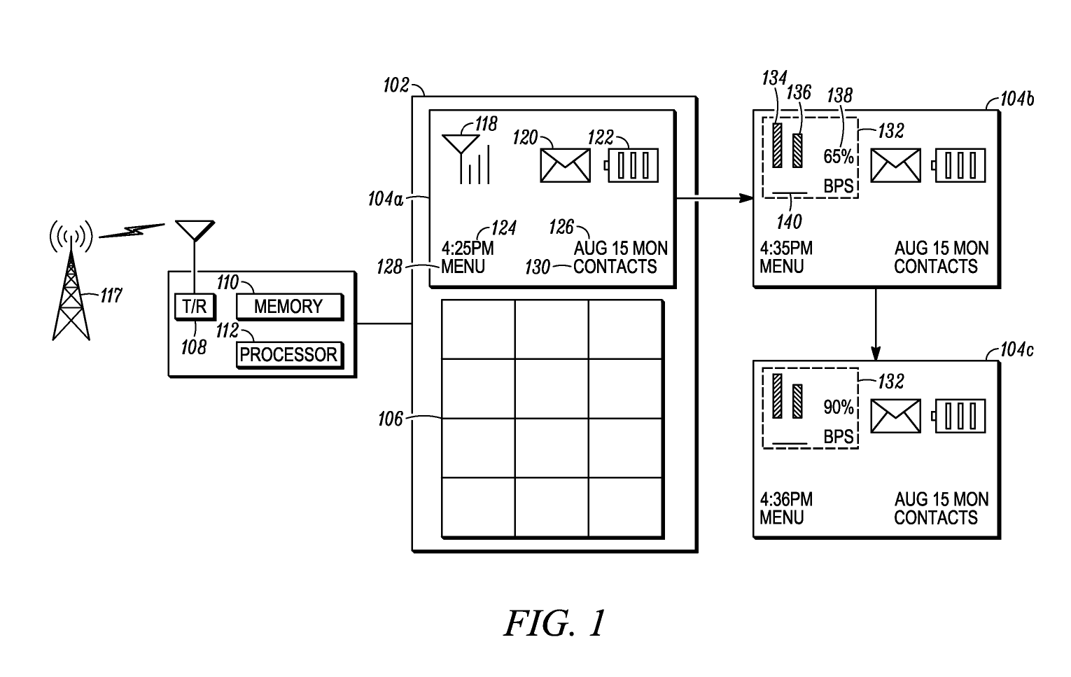

FIG. 1 shows an embodiment of a mobile communication device, some of its components, a base transceiver station forming part of a wireless communication network, and more particularly, display elements including first a wireless link quality indicator and then the transfer data rate throughput indicator in place of the wireless link quality indicator. The mobile communication device 102 includes an annunciation device, in this case, a display device 104a, 104b and 104c.

The mobile communication device 102 represents a wide variety of communication devices that have been developed for use within various networks. Such handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless and wired communication technologies include the capability of transferring high content data. For example the mobile communication device 102 can provide Internet access and/or multi-media content access. The electronic device 102 includes input capability such as a key pad 106, a transmitter and receiver 108, a memory 110, a processor 112. The processor 112 generally includes one or more modules, which can be implemented in software, such as in the form of one or more sets of prestored instructions, and/or hardware, which facilitate the operation of the electronic device as discussed below.

A base transceiver station 117 forming part of a wireless communication network as described herein includes those used to transmit digital data through radio frequency links. The links may be between two or more devices, through radio towers such as those illustrated in FIG. 1, or any other configuration. Examples of communication networks are telephone networks, messaging networks, and Internet networks. Such networks include land lines, radio links, and satellite links, and can be used for such purposes as cellular telephone systems, Internet systems, computer networks, messaging systems and satellite systems, singularly or in combination. Furthermore, there are fixed and ad hoc networks, including long and short range data transfers such as those transmitting under various protocols such as USB, Firewire, Ethernet, CDMA1X, EVDO, WLAN, UWB, GSM, Edge, Wideband CDMA and Bluetooth.

Returning to the discussion of annunciation by the display device 104a, 104b and 104c, several icons are shown. In particular, prior to the data transfer transaction, the signal strength icon 118 may show an antenna symbol and some bars. The number of bars may be correlated to the strength of the signal. Other elements not necessarily related to this discussion such as voice mail messages 120, battery life 122, the time 124, the data 126, drop down menu 128 and contacts 130 may also share the display screen in any form or combination. In the event that the device is turned on simultaneously with the initiation of a data transfer transaction so that the signal strength icon 118 as shown in FIG. 1 may not be visible on the display, however, a data transfer rate throughput value will still replace the signal strength icon since it would otherwise be annunciated.

The sequence of the display screens 104a, 104b and 104c shows the change in the information provided related to instances in which the wireless link quality is indicated and the data transfer rate throughput value corresponding to a data transfer transaction is indicated. When a data transfer transaction begins or is initiated, monitoring of the data transaction starts. The wireless link quality icon 118 will not be indicated but a transfer data rate throughput value 132 will be annunciated. While in this description the transfer data rate throughput value is shown as an icon on a display screen of a mobile communication device, which is shown in place of the wireless link quality indicator, the value of the transfer data rate throughput may be additionally annunciated in any manner, including audibly. The information provided by the annunciation can be one piece of information, or may be a combination of information as shown in FIG. 1.

FIG. 1 illustrates a display to indicate the transfer data throughput values including two bars. It is understood that any type of annunciation is within the scope of this discussion. The grading by bars or any other icon can be distinguished, for example, according to color or illumination. The first bar 134 is an expected maximum throughput value which will be discussed in more detail below. The second bar 136 is a value calibrated against the expected maximum throughput value. As shown in the figure, bar 136 represents 65% percent 138 of the expected maximum throughput value. Below the bars may be the rate at which the mobile electronic device 102 determines that data transfer units 140 that are being transferred. In this example, the number is in BPS (Bits Per Second) however, any metric may be used. Furthermore, filtering, and/or averaging over predetermined periods of time, of the actual number of data transfer units can be provided prior to annunciation, which will be discussed below in more detail.

As mentioned above, as with voice data reception quality, position and orientation of the mobile communication device 102, even for small changes, may affect the transfer data rate throughput value. In the event that a user found a transfer data rate throughput value of 65% of the expected maximum throughput value to be inadequate, the user may attempt to adjust the position and/or orientation of the mobile communication device. Therefore, between display screens 104b and 104c the user may find a better position and/or orientation for the mobile device so that the transfer data rate throughput value rises to 90%.

In the event that the user obtained a transfer data rate throughput value of 65% of the expected maximum throughput value but was unable to improve the value through manipulation of the device 102, the user may sometimes choose to abort the download and attempt the transaction communication conditions are more favorable, for example when competing network traffic between other devices is lower.

The user may view the dynamic evaluation of the transfer data rate throughput values on the display screen during the data transfer transaction to determine if drift away from a particular throughput value may have occurred. In the event that the value changes, the user may attempt to physically adjust the device for improvement of the data transfer rate, change to a different network (for example switch from WLAN to a cellular network), or the user may choose to reschedule the transfer when they have better coverage. The device 102 can also include an alarm which will alert the user when the throughput value falls below a predetermined percentage of the expected maximum transfer value. For example, the user may wish to complete a transaction within a certain period of time. The user may find that a transaction should be completed in two minutes if the throughput value remains at 85% of the expected throughput rate. If the rate falls to 84% or below, the device will alert the user that the throughput value falls below or equals a predetermined threshold. The device may make an audible sound, generate a vibration, flash lights, or use any other method for generating an alert. In this way the user can be alerted, so that, if desired, they may attempt to adjust the handset, in the event that a change in position or orientation may be beneficial.

Other situations can be the cause for an alert as well. For example, in the event that there is a sudden drop in the throughput value, the user can be alerted. Also, if there is a sudden increase the user can be alerted. Additionally, the user can be alerted when the throughput value equals the expected maximum value or another threshold value. The user can also be alerted upon start and/or completion of the transaction. The alert values as well as other threshold values described herein may be preferences programmed by the user, may be preset or may be downloaded to the device.

The dynamic evaluation of the transfer data rate throughput value can be annunciated to the user in any manner. For example, while FIG. 1 shows a display with bars and a calibrated percentage of the actual rate against the expected throughput rate, the configuration of the display may take any suitable form. The information may be annunciated audibly or by any other manner.

The dynamic evaluation of the transfer data rate throughput value, in real time may be somewhat fast moving around a particular value. To reduce current drain and to facilitate easier monitoring, the displayed rate can be modified or filtered with respect to the real time transfer rate over a predetermined time period. Accordingly, the average of the throughput value can be displayed instead of the value in real time. The average over a predetermined time period may also, or instead, be considered as incorporating a time constant. The time constant is used in an algorithm to display the updated value, herein referred to as a time constant algorithm. The time constant helps to smooth negative and positive jumps in the data rate caused by environmental effects, or any other factor. Other modification algorithms may also be used. Generally, for signal strength, the icon is updated at two second intervals. A more instantaneous update for transfer data rate throughput value may be more desirable and can be provided with a modification of the time constant algorithm. More instantaneous update may allow the user to get more immediate feedback relative to small adjustments in location and orientation. In at least one embodiment, a value of 0.5 seconds is used in connection with displaying data throughput, to provide feedback to the user, which is closer to real time, as the position of the device is adjusted for more optimal throughput.

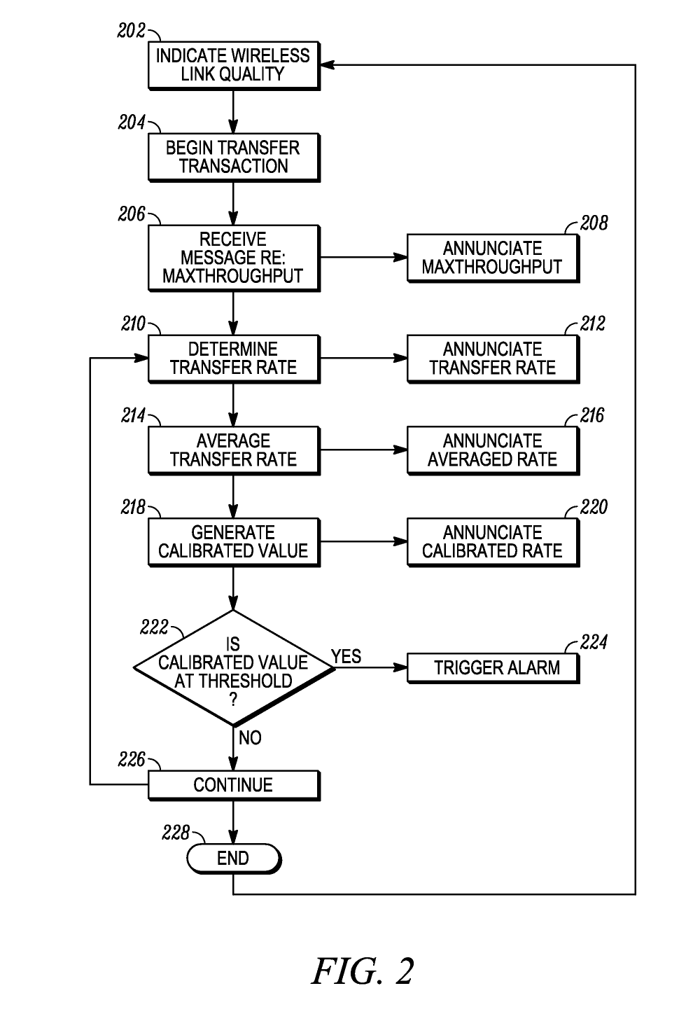

FIG. 2 is a flow chart of an embodiment of the method described herein for initiating the transfer data rate throughput value and annunciating the rate in place of the wireless link quality indicator. As discussed above, prior to the transfer, the device indicates the wireless link quality 202, typically through a signal strength icon on its display device. The device will then begin to process a data transfer transaction 204.

Preliminarily, the mobile communication device monitors the quality of the channel and communicates to the base station at what rate to send data. Since the base station is made aware of the device's capabilities via communication from the device to the base station, the base station will communicate to the device the transfer rate. The base station or network 117 delivers a message 206 to the device 102 regarding the expected maximum throughput value which may in turn be annunciated by the display device 208. Alternatively, the maximum throughput may be known by the device for the particular type of network that the device is presently connected. The total number of data transfer units of the transaction can also be delivered to the device so that expected delivery time can be calculated, either by the base station or the device.

As the transaction begins, the device determines the transfer data rate throughput value 210 which in turn can be annunciated 212. The value first may be averaged over a predetermined period of time 214 and that averaged value may be annunciated 216. Hardware and/or software modules provide instructions to the processor of the device to enable detecting and monitoring.

Based upon the expected maximum throughput value and the determined or averaged throughput value, a calibrated value may be generated 218 which can be annunciated in the form of a percentage value 220. As discussed above, the device can also monitor the value of the throughput based on threshold criteria 222 to generate an alarm which will alert the user 224 when the throughput value fails to exceed a threshold value. The process continues 226, returning to step 210 if the transfer is not complete. Furthermore, the throughput value may equal a value which indicates that the transfer is complete, in which event the process continues 226 to end 228 and then the wireless link quality icon can be indicated 202 in place of the transfer data rate throughput value icon. While the steps in FIG. 2 are illustrated in a particular order, it is understood that certain steps may occur simultaneously or in a different order.

It is to be understood that other methods of displaying throughput could be used. For instance, the value could be expressly articulated (400 Kbps), the value could be a percentage of maximum rate (47%), the display could be a series of bars where the higher bars imply higher data throughput.

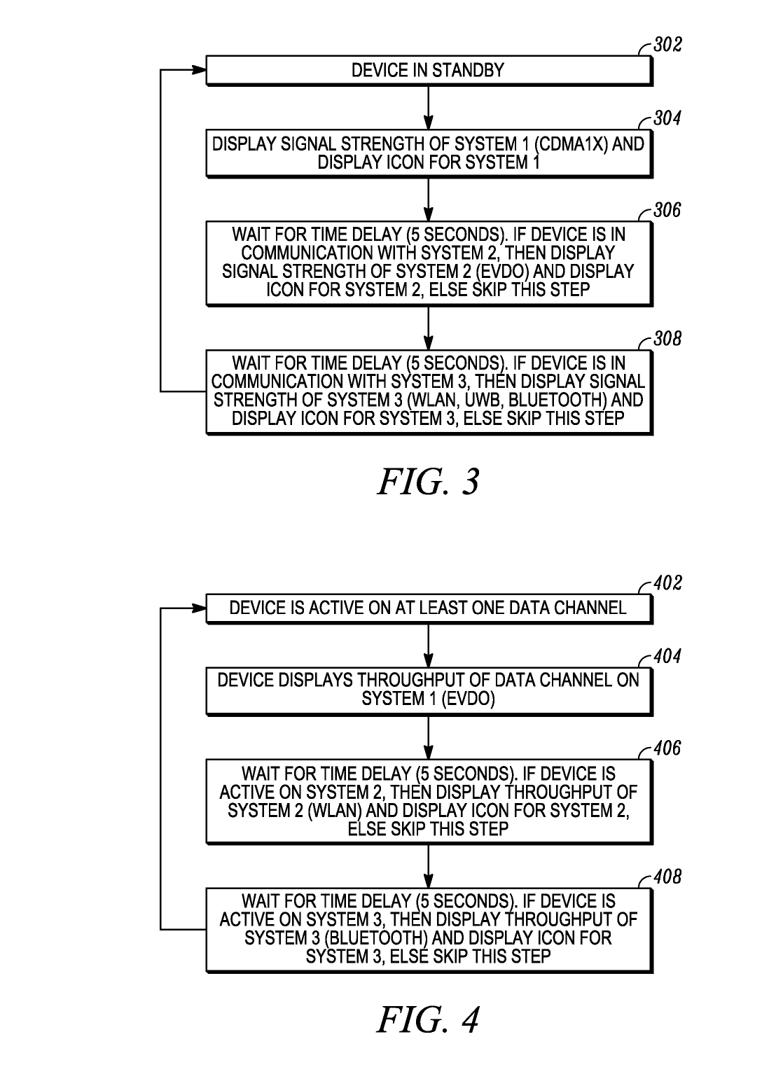

FIG. 3 is a flow chart of an embodiment of the method including indicating the signal strength value for a plurality of networks. The plurality of networks that are in communication with the mobile communication device may be different from one another, and each may have a different protocol. As discussed above, in standby 302 prior to the transfer transaction, the quality of the wireless link is indicated for at least one network while the device is in standby 304. After a time delay, such as five seconds, if the mobile communication device is in communication with a second network, a display icon for the signal strength of the second system can be indicated 306. Similarly, after a predetermined time delay such as five seconds, if the mobile communication device is in communication with three or more network systems, a display icon for the signal strength of the third or more systems can be indicated 308. As indicated by FIG. 3, there are various types of data transfers, such as CDMA1X, EVDO, WLAN, UWB, and Bluetooth. Although only three networks are shown in FIG. 3, it will be understood that any number of network signal strengths could be shown.

In a similar manner as described above with respect to a single data transfer transaction, a plurality of data transfer transactions may take place in sequence, overlapping or simultaneously. FIG. 4 is a flow chart of an embodiment of the method for indicating the transfer data rate throughput value for at least a second system while there is a first data transfer transaction occurring. As in FIG. 2, the first data transfer may be initiated 402. As previously described with respect to a single transaction, the device can annunciate transfer data rate throughput value of a first channel, which, for example, may be EVDO, as shown. Then, the device alternatively annunciates the throughput values of each of two throughput values 406. For example, there can be a time delay of, for example, five seconds, if the device is active on a second channel such as a WLAN. Then, the device alternatively annunciates the throughput values of each of three or more throughput values 408. For example, there can be a time delay of, for example, five seconds, if the device is active on a third channel such as Bluetooth. The transfer data rate throughput value is then annunciated. Once the data transfer transactions are complete the signal strength icon may replace the transfer data rate throughput values icons. Although only three channels are discussed in connection with FIG. 4, it will be understood that any number of transfer data rate throughput values associated with a plurality of different channels could be shown, and sequentially and/or alternatively be displayed.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method for indicating data transfer rate in a data transfer transaction, comprising:
indicating a quality of a wireless link;
transferring data wirelessly, the transferred data comprising data transfer units;
determining the transfer data rate throughput value; and
annunciating the transfer data rate throughput value in place of indicating the wireless link quality.

2. A method as recited in claim 1, further comprising:
transferring data of a plurality of data transfer transactions;
counting the number of data download units per time measure while transferring data of the plurality of data transfer transactions to generate a plurality of transfer data rate throughput values; and
annunciating the plurality of transfer data rate throughput values.

3. A method as recited in claim 2 further comprising:
annunciating the transfer data rate throughput values of the plurality of transfer data rate throughput values alternatively.

4. A method as recited in claim 1 further comprising:
indicating a quality of a wireless link at a first update rate;
annunciating the transfer data rate at a second update rate;
wherein the second update rate is faster than the first update rate.

5. A method as recited in claim 1 further comprising:
activating annunciating when data transfer wirelessly begins.

6. A method as recited in claim 1, further comprising:
transferring a message comprising an expected maximum throughput rate for data transfer transaction.

7. A method as recited in claim 6, further comprising:
annunciating the expected maximum throughput rate of the data transfer transaction.

8. A method as recited in claim 6, further comprising:
calibrating the transfer data rate throughput value against the expected maximum throughput value to generate a calibrated throughput value; and
annunciating the calibrated throughput value.

9. A method as recited in claim 1, further comprising:
triggering an alarm when the transfer data rate throughput value exceeds a predetermined threshold value.

10. A method as recited in claim 1, further comprising:
transferring a message comprising a file size for the data transfer transaction;
calculating the time expected for transferring data based on the transfer data rate throughput value and the file size to generate a time expected value; and
annunciating the time expected value.

11. A method as recited in claim 1 wherein annunciating the transfer data rate throughput value comprises:
generating graphic metrics for display on a display device.

12. A method as recited in claim 1 comprising:
monitoring changes in the transfer data rate throughput value to generate a change in throughput value; and
annunciating a change in throughput value.

13. A method for indicating data transfer rate in a plurality of data transfer transactions, comprising:
transferring data of the plurality of data transfer transactions wirelessly, the transfer data comprising data transfer units;
determining a number of data transfer units per time measure of the plurality of data transfer transactions to generate a plurality of transfer data rate throughput value; and
annunciating the plurality of transfer data rate throughput values.

14. A method as recited in claim 13 further comprising:
alternatively annunciating the transfer data rate throughput values of each of the plurality data transfer transactions.

15. A circuit for indicating throughput, comprising:
an indicator for indicating a quality of wireless link value;
a transceiver for transferring data wirelessly, the data comprising data transfer units;
a processor for determining a data transfer rate throughput value; and
an indicator for annunciating the throughput value in place of indicating the wireless link quality.

16. A circuit as recited in claim 15 further comprising:
a switch to activate the processor for determining a data transfer rate throughput value when transferring data wirelessly begins.

17. A circuit as recited in claim 15 further comprising:
a switch to activate the indicator when data transfer wirelessly begins.

18. A circuit as recited in claim 15 wherein the receiver is further for transferring a message comprising an expected maximum bit rate for transferring data, the circuit further comprising:
a calibrator for calibrating the transfer data rate throughput value with the expected maximum value to generate a calibrated throughput value and wherein the indicator is for further annunciating the calibrated throughput value.

19. A circuit as recited in claim 18, further comprising:
an alarm trigger for triggering an alarm when the transfer data rate throughput value equals a predetermined threshold value.

20. A circuit as recited in claim 15 wherein the circuit is a component of a cellular communication device.
